(19) United States
(12) Patent Application Publication
(10) Pub. No.: US 2025/0376921 A1
(43) Pub. Date: Dec. 11, 2025

(54) METHOD FOR DETERMINING MULTIPLE WELL POSITIONS OF OIL OR GAS RESERVOIRS USING NEURAL NETWORK MODEL

(71) Applicant: Industry-Academic Cooperation Foundation, Chosun University, Gwangju (KR)

(72) Inventor: Il Sik JANG, Gwangju (KR)

(73) Assignee: Industry-Academic Cooperation Foundation, Chosun University, Gwangju (KR)

(21) Appl. No.: 18/944,304

(22) Filed: Nov. 12, 2024

(30) Foreign Application Priority Data
Jun. 11, 2024 (KR) 10-2024-0075961

(51) Int. Cl. E21B 47/022; G01V 20/00

(52) U.S. Cl. CPC E21B 47/022; G01V 20/00; E21B 2200/20

(57) ABSTRACT

The present disclosure relates to a method for determining multiple well positions in which a maximum value of a total oil or gas production amount or a net present value (NPV) is expected in a 3D grid model for oil or gas reservoirs partitioned into multiple default grids.

### CROSS REFERENCE TO RELATED APPLICATION

The present application claims priority to Korean Patent Application No. 10-2024-0075961, filed Jun. 11, 2024, the entire contents of which are incorporated herein for all purposes by this reference.

### BACKGROUND

### Technical Field

The present disclosure relates to a method for determining multiple well positions in which a maximum value of a total oil or gas production amount or a net present value (NPV) is expected on oil or gas reservoirs through a neural network model.

### Description of the Related Art

In order to determine an oil and gas well position, a simulation using a computational model is performed in a technical field. Specifically, the prior art determines a well position which can maximize an oil or gas production amount by modeling oil or gas reservoirs in a 3-dimensional grid, and calculating an oil or gas discharge amount according to a well position through a computational model.

However, such a scheme may be applied when determining a single well position, but has a disadvantage in that the number of cases to be applied to the computational model exponentially increases determining multiple well positions, so tremendous time and resources are required for inferring an oil or gas production amount for the number of all cases.

### SUMMARY

The present disclosure has been made in an effort to accurately determine multiple well positions in which a maximum value of a total oil or gas production amount or a net present value (NPV) is expected even in an environment in which a complexity of oil or gas reservoirs is high.

The objects of the present disclosure are not limited to the above-mentioned objects, and other objects and advantages of the present disclosure that are not mentioned can be understood by the following description, and will be more clearly understood by embodiments of the present disclosure. Further, it will be readily appreciated that the objects and advantages of the present disclosure can be realized by means and combinations shown in the claims.

In order to achieve the object, an exemplary embodiment of the present disclosure provides a method for determining multiple well positions in a 3D grid model for oil or gas reservoir partitioned into multiple default grids, which includes: identifying, by a processor, each of candidate groups of multiple well positions in the grid model through a population-based optimization algorithm (hereinafter, referred to as POA); partitioning, by the processor, the grid model into first grids larger than a default grid, and determining each of multiple first regions including each candidate group; repeating, by the processor, an operation of setting first combinations of representative positions in each first region as a first search space, inputting the first search space into a pre-trained neural network model, and identifying a prediction value for each combination, and reducing the first search space; identifying, by the processor, a first fitness by inputting the reduced first search space into the computational model, and partitioning the grid model into second grids smaller than the first grids to determine multiple second regions including respective candidate groups of multiple well positions corresponding to the first combination in which the first fitness is equal to or more than a reference value; repeating, by the processor, an operation of setting second combinations of representative positions in each second region as a second search space, inputting the second search space into the neural network model, and identifying a prediction value for each combination, and reducing the second search space; identifying, by the processor, a second fitness by inputting the reduced second search space into the computational model, and partitioning the grid model into third grids smaller than the second grids to determine multiple third regions including respective candidate groups of multiple well positions corresponding to the second combination in which the second fitness is equal to or more than a reference value; repeating, by the processor, an operation of setting third combinations of all default grids within any one third region among the multiple third regions, and representative positions within the remaining third regions as a third search space, inputting the third search space into the neural network model, and identifying a prediction value for each combination, and updating third combinations in which the prediction value is equal to or more than a reference value to the third search space to reduce the third search space; and inputting, by the processor, the reduced third search space into the computational model, and determining a well position having a maximum fitness with respect the any one third region.

In an exemplary embodiment, the POA is any one of a genetic algorithm (GA), a particle swarm optimization (PSO) algorithm, and a designed exploration and controlled evolution (DECE) algorithm.

In an exemplary embodiment, the identifying of the candidate groups of the multiple well positions includes identifying, as the candidate groups of the multiple well positions, combinations of multiple well positions having a solution having a predetermined upper rank by repeatedly applying the POA to the grid model a reference number of times.

In an exemplary embodiment, an objective function of the POA is set to be in proportion to a total oil or gas production amount or a net present value (NPV).

In an exemplary embodiment, the determining of the first region includes determining each of the first grids disposed to be adjacent to each other, and including the candidate groups of the multiple well positions, respectively as the first region.

In an exemplary embodiment, the neural network model is pre-trained to receive grids combined with the number of target well positions in the grid model, and output a global solution which is in proportion to the total oil or gas production amount or the net present value (NPV).

In an exemplary embodiment, the neural network model is subjected to supervised learning based on training data having multiple training grid combinations selected in the first search space as input data, and a calculation value output by inputting the training grid combinations into the computational model as output data.

In an exemplary embodiment, the reducing of the first search space includes supervised learning the neural network model again by adding a first combination except for the training grid combination among the first combinations in which the prediction value is equal to or more than the reference value to the training data, and re-identifying the updated first search space into the re-trained neural network model, and re-updating the first combinations in which the re-identified prediction value is equal to or more than the reference value to the first search space.

In an exemplary embodiment, the re-updating of the first search space is repeated until the number of first combinations except for the training grid combination becomes smaller than a reference number.

In an exemplary embodiment, the identifying of the first and second fitnesses includes inputting the first and second search spaces into the computational model preset to output a fitness which is in proportion to the total oil or gas production amount or the net present value (NPV).

In an exemplary embodiment, the third grid is the same as the default grid, or is large within a reference range.

In an exemplary embodiment, the determining of the second and third regions includes identifying second and third grids disposed to be adjacent to each other, and including respective candidates of multiple well positions corresponding to the first and second combinations, and determining regions in which the second and third grids are expanded by a reference margin as the second and third regions, respectively.

In an exemplary embodiment, the any one third region is selected in order of smaller width among the multiple third regions.

In an exemplary embodiment, the method for determining multiple well positions further includes: repeating, by the processor, an operation of setting fourth combinations of the determined well position of any one third region, all default grids within another third region among the multiple third regions, and representative positions within the remaining third regions as a fourth search space, inputting the fourth search space into the neural network model, and identifying a prediction value for each combination, and updating fourth combinations in which the prediction value is equal to or more than a reference value to the fourth search space to reduce the third search space; and inputting, by the processor, the reduced fourth search space into the computational model, and determining a well position having a maximum fitness with respect another third region.

According to the present disclosure, there is an advantage in that it is possible to specify a well position with a small time and resources, and high accuracy even in oil or gas reservoirs in which a size of a search space is very large by appropriately combining a population-based optimization algorithm (POA) and an inference operation of a neural network model.

In addition to the above-described effects, the specific effects of the present disclosure are described together while describing specific matters for implementing the invention below.

### BRIEF DESCRIPTION OF THE DRAWINGS

FIG. 1 is a diagram illustrating an example of a 3-dimensional grid model for oil or gas reservoirs.

FIG. 2 is a flowchart for describing a method for determining multiple well positions according to an exemplary embodiment of the present disclosure.

FIG. 3 is a diagram illustrating a candidate group of multiple well positions determined through a population-based optimization algorithm (POA).

FIG. 4 is a diagram illustrating regions each including the candidate group illustrated in FIG. 3.

FIG. 5 is a flowchart illustrating a method for reducing a search space using a neural network model according to an exemplary embodiment of the present disclosure.

FIG. 6 is a diagram illustrating only an area having a higher fitness than a reference value among multiple regions illustrated in FIG. 4.

FIG. 7 is a diagram illustrating expansion regions each including the area illustrated in FIG. 6.

FIG. 8 is a diagram illustrating only an area having a higher fitness than a reference value among the expansion regions illustrated in FIG. 7.

FIG. 9 is a diagram illustrating an expansion region for any one area of the areas illustrated in FIG. 8.

FIG. 10 is a diagram illustrating multiple well positions determined in the area illustrated in FIG. 9.

FIGS. 11 to 15 are diagrams for sequentially describing one implement example of the present disclosure.

FIG. 16 is a diagram illustrating a comparison between a performance of present invention and a designed exploration and controlled evolution (DECE) algorithm.

### DETAILED DESCRIPTION

The above-mentioned objects, features, and advantages will be described in detail with reference to the drawings, and as a result, those skilled in the art to which the present disclosure pertains may easily practice a technical idea of the present disclosure. In describing the present disclosure, a detailed description of related known technologies will be omitted if it is determined that they unnecessarily make the gist of the present disclosure unclear. Hereinafter, a preferable embodiment of the present disclosure will be described in detail with reference to the accompanying drawings. In the drawings, the same reference numeral is used for representing the same or similar components.

Although the terms “first”, “second”, and the like are used for describing various components in this specification, these components are not confined by these terms. The terms are used for distinguishing only one component from another component, and unless there is a particularly opposite statement, a first component may be a second component, of course.

Further, in this specification, any component is placed on the “top (or bottom)” of the component or the “top (or bottom)” of the component may mean that not only that any configuration is placed in contact with the top surface (or bottom) of the component, but also that another component may be interposed between the component and any component disposed on (or under) the component.

In addition, when it is disclosed that any component is “connected”, “coupled”, or “linked” to other components in this specification, it should be understood that the components may be directly connected or linked to each other, but another component may be “interposed” between the respective components, or the respective components may be “connected”, “coupled”, or “linked” through another component.

Further, a singular form used in the present disclosure may include a plural form if there is no clearly opposite meaning in the context. In the present disclosure, a term such as “comprising” or “including” should not be interpreted as necessarily including all various components or various steps disclosed in the present disclosure, and it should be interpreted that some component or some steps among them may not be included or additional components or steps may be further included.

In addition, in this specification, when the component is called “A and/or B”, the component means, A, B or A and B unless there is a particular opposite statement, and when the component is called “C or D”, this means that the term is C or more and D or less unless there is a particular opposite statement.

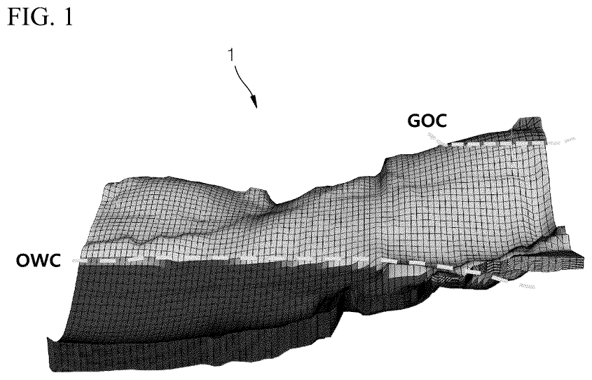

The present disclosure relates to a method for determining multiple well positions in which a maximum value of a total oil or gas production amount or a net present value (NPV) is expected on oil or gas reservoirs through a neural network model, and particularly, to a method for determining multiple well positions in a 3D grid model for oil or gas reservoirs partitioned into multiple default grids. Hereinafter, a technical field applied to the present disclosure, and prior art for determining multiple well positions will first be described with reference to FIG. 1.

FIG. 1 is a diagram illustrating an example of a 3D grid model for oil or gas reservoirs. Referring to FIG. 1, the oil or gas reservoirs may be modeled with the 3D grid in order to determine a well position, and partitioned into multiple default grids. In an example of FIG. 1, the oil or gas reservoirs may include water at a lower portion and oil at an upper portion based on an oil water contact (OWC), and include the oil at the lower portion and gas at the upper portion based on a gas oil contact (GOC).

In order to determine an optimal well position by using the grid model 1, a virtual well position is arbitrarily set at each grid position of the grid model 1 in the prior art, and the well position is specified by an inductive scheme which calculates the resulting oil or gas discharge amount through a computational model. Here, the computational model as an arbitrary simulation tool which calculates an oil or gas production amount when inputting information on the well position may be a concept including various software tools utilized in the technical field.

According to the existing scheme, only after the oil or gas production amount for all grids constituting the grid model 1, the well position may be specified. As a result, such a scheme may be applied when determining a single well position, but has a limit in that a combination of well positions to be applied to the computer model, that is, the number of cases exponentially increases when determining multiple well positions, so tremendous time and resources are required for inferring an oil or gas production amount for the number of all cases.

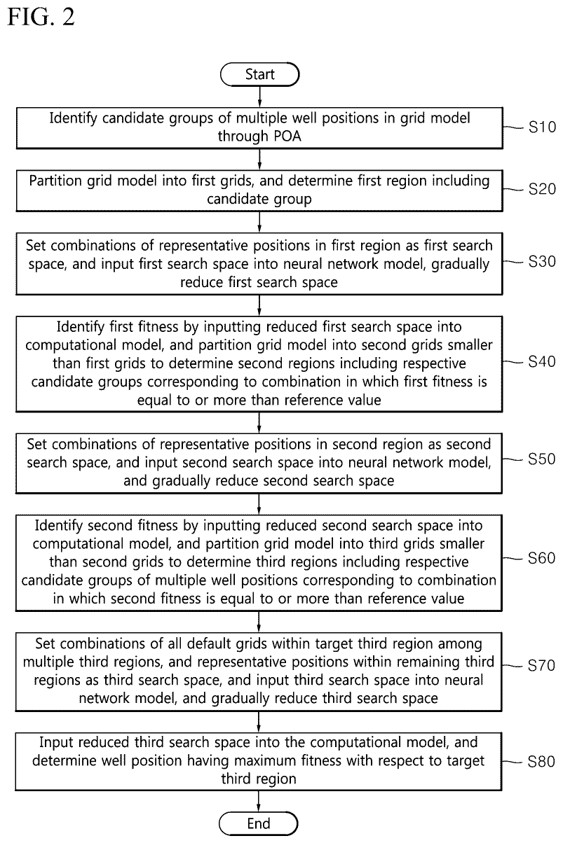

The present disclosure is an invention for overcoming the limit, and hereinafter, the method for determining a multiple well positions according to an exemplary embodiment of the present disclosure will be described in detail with reference to FIGS. 2 to 16.

FIG. 2 is a flowchart for describing a method for determining multiple well positions according to an exemplary embodiment of the present disclosure.

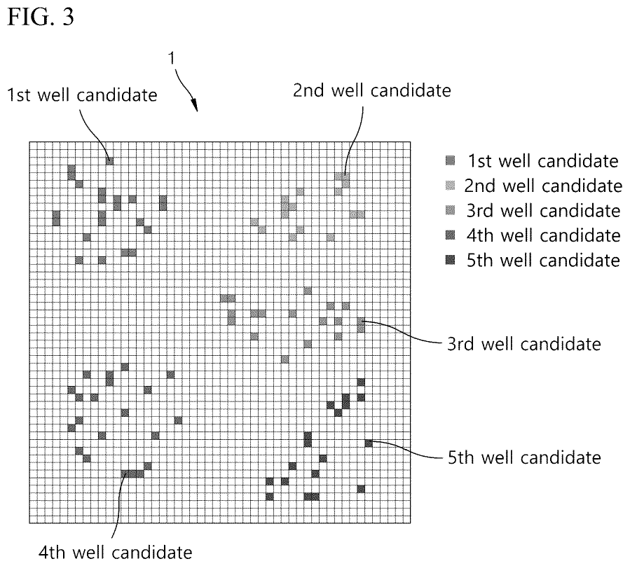

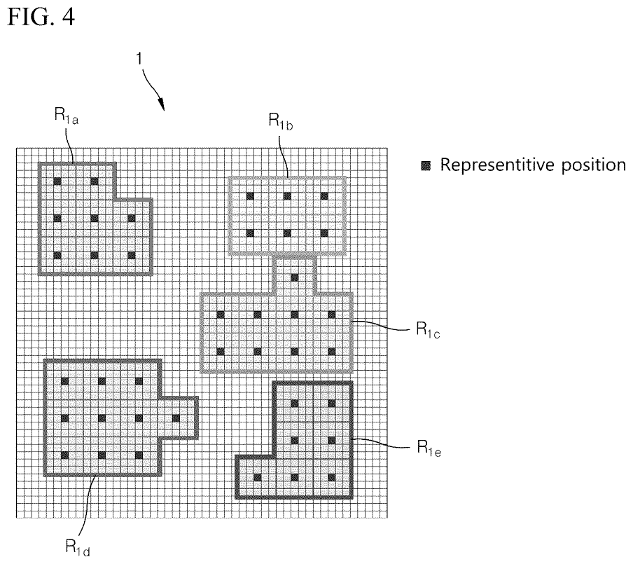

FIG. 3 is a diagram illustrating a candidate group of multiple well positions determined through a population-based optimization algorithm (POA), and FIG. 4 is a diagram illustrating regions each including the candidate group illustrated in FIG. 3.

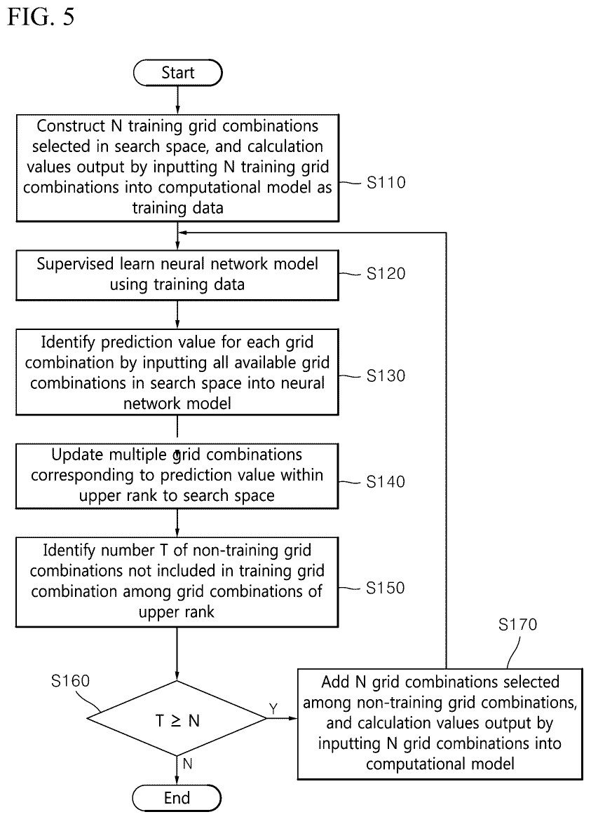

FIG. 5 is a flowchart illustrating a method for reducing a search space using a neural network model according to an exemplary embodiment of the present disclosure.

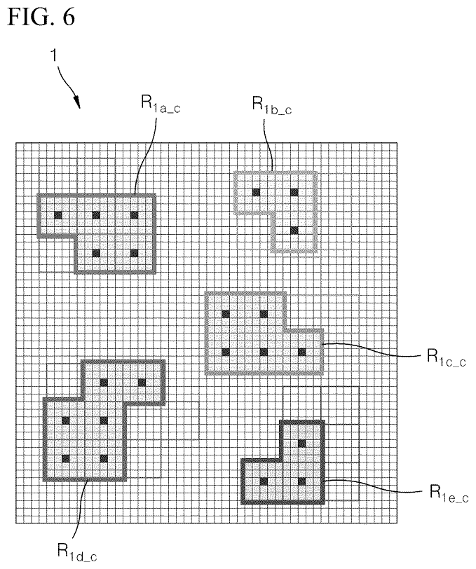

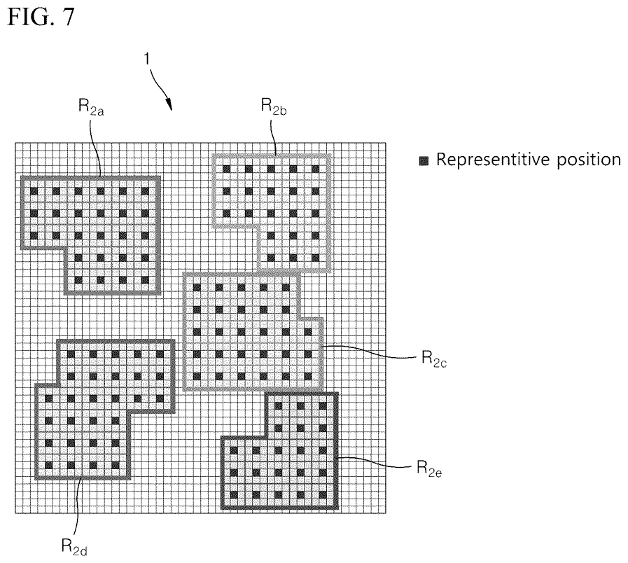

FIG. 6 is a diagram illustrating only an area having a higher fitness than a reference value among multiple regions illustrated in FIG. 4, and FIG. 7 is a diagram illustrating expansion regions each including the area illustrated in FIG. 6.

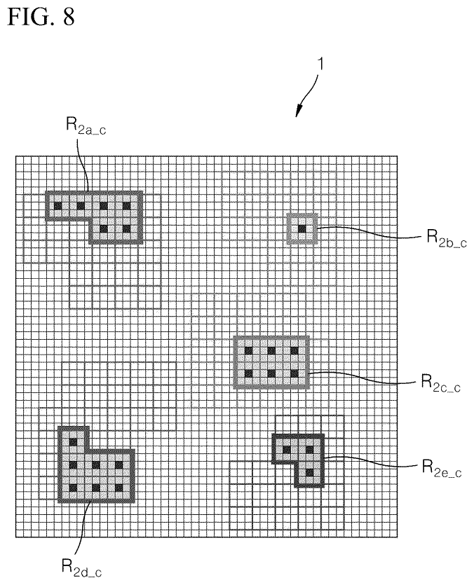

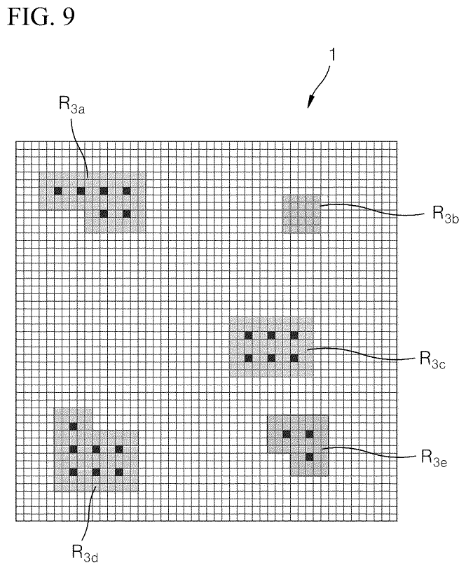

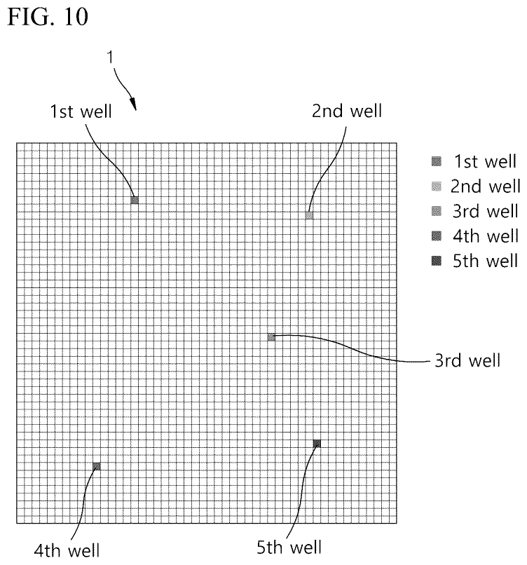

FIG. 8 is a diagram illustrating only an area having a higher fitness than a reference value among the expansion regions illustrated in FIG. 7, FIG. 9 is a diagram illustrating an expansion region for any one area of the areas illustrated in FIG. 8, and FIG. 10 is a diagram illustrating multiple well positions determined in the area illustrated in FIG. 9.

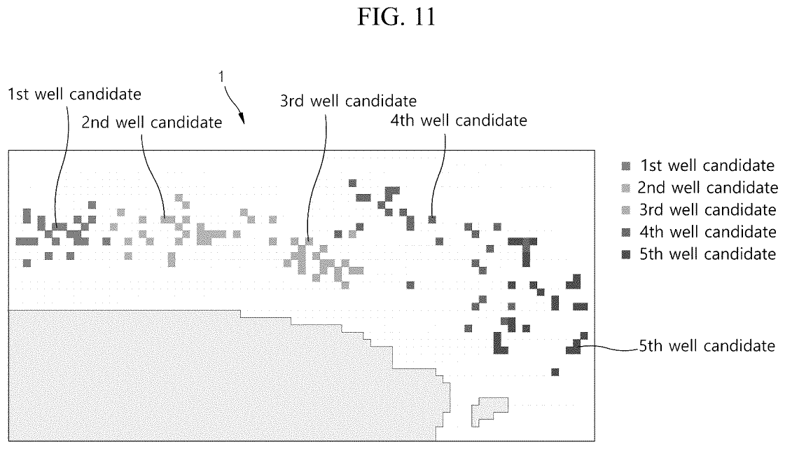

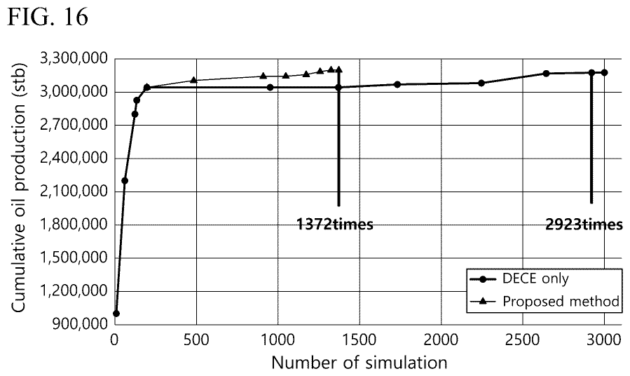

FIGS. 11 to 15 are diagrams for sequentially describing one implement example of the present disclosure, and FIG. 16 is a diagram illustrating a comparison between a performance of present invention and a designed exploration and controlled evolution (DECE) algorithm.

Referring to FIG. 2, the method for determining multiple well positions according to an exemplary embodiment of the present disclosure may include a step S10 of identifying a candidate group of multiple well positions in a grid model through a population-based optimization algorithm (POA), a step S20 of determining a first region including the candidate group by partitioning the grid model into first grids, a step S30 of setting combinations of representative positions in the first region, and gradually reducing the first search space by inputting the first search space into a neural network model, and a step S40 of identifying a first fitness by inputting the reduced first search space into a computational model, and partitioning the grid model into second grids smaller than the first grids, and determining a second region including each candidate group corresponding to a combination in which the first fitness is more than a reference value.

Subsequently, the method for determining multiple well positions according to an exemplary embodiment of the present disclosure may include a step S50 of setting combinations of representative positions in the second region as a search space, and gradually reducing the second search space by inputting the second search space into the neural network model, and a step S60 of identifying a second fitness inputting the reduced second search space into the computational model, and partitioning the grid model into third grids smaller than the second grids, and determining a third region including each candidate group corresponding to a combination in which the second fitness is more than, a reference value.

Subsequently, the method for determining multiple well positions according to an exemplary embodiment of the present disclosure may include a step S70 of setting combinations of all default grids in a target third region among multiple third regions, and representative positions in the remaining third regions as a third search space, and a step S80 of inputting a third search space into the neural network mode, and gradually reducing the third search space, and determining a well position having a maximum fitness for the target region.

However, the method for determining the multiple well positions illustrated in FIG. 2 follows an exemplary embodiment, respective steps constituting the invention are not limited to the exemplary embodiment illustrated in FIG. 2 and if necessary, some steps may be added, modified, or deleted.

The respective steps illustrated in FIG. 2 may be performed by a processor implemented as a central processing unit (CPU), a graphic processing unit (GPU), etc., and the processor may further include at least one physical element among application specific integrated circuits (ASICS), digital signal processors (DSPs), digital signal processing devices (DSPDs), programmable logic devices (PLDs), field programmable gate arrays (FPGAs), a controller, and micro-controllers in order to perform the respective steps.

Hereinafter, the respective steps illustrated in FIG. 2 will be described in detail.

The processor applies a population-based optimization technique (hereinafter, referred to as POA) to the 3D grid model 1 for oil or gas reservoirs partitioned into multiple default grids to identify a candidate group of multiple well positions in the grid model (S10).

Here, the POA as a methodology which finds an optimal solution combination in which an objective function becomes maximum or minimum while repeatedly changing multiple resolutions which may be determined in a search space.

The processor may identify a combination of multiple well positions by applying the POA to the grid model 1. At this time, when the POA is indefinitely applied, an optimal position of the multiple well positions may be determined, but this may require significantly time and resources like the limit of the prior art.

As a result, in the present disclosure, the processor may repeatedly apply the POA a reference number of times for the grid model 1, and thus multiple combinations of well positions having a resolution of an identified upper rank may be identified.

Hereinafter, an operation of the present disclosure will be exemplarily described with reference to the drawings. Meanwhile, for convenience of description, the grid model 1 is illustrated and described in two dimensions, but the operation of the present disclosure to be described below may also be applied to the 3D grid model 1, of course.

Referring to FIG. 3, the processor may derive combinations of positions of five wells which maximize an objective function which is in proportion to a total oil or gas production amount or a net present value (NPV) by repeatedly applying the POA, specifically, a DECE algorithm to the grid model 1.

For example, when candidate groups of positions of first to fifth wells are expressed as w₁ to w₅, the processor may derive n combination, specifically, w₁_n, w₂_n, w₃_n, w₄_n, and w₅_n, which maximize the objective function through five repetitions of the DECE algorithm, and identify combinations of multiple well positions having solutions up to 30 as the candidate groups of the multiple well positions.

The candidate groups of the multiple well positions identified as such are illustrated in FIG. 3, and the combinations of the well positions having the solution of the upper rank may redundantly include the same position, so the number of candidate groups at any one well position may be less than 30.

Subsequently, the processor may determine each of multiple first regions including each candidate group identified above by partitioning the grid model 1 into first grids than the default grid.

As illustrated in FIG. 3, candidate groups of respective well positions may be identified to be adjacent to each other. The processor may determine a first partition which partitions each of them, and determine the first region so that each portioned area has the first grid larger than the default grid.

When described with reference to FIG. 4, the processor may partition the grid model 1 into a first grid of 5×5 larger than an default grid of 1×1, and may determine one or more first grids including all candidate groups the respective wells identified above as first regions R₁ₐ, R_{1b}, R_{1c}, R_{1d}, and R₁ₑ for the respective wells.

At this time, in order to consider the candidate groups of all well positions identified in the step S10, the processor may determine first grids to be adjacent to each other to share a corner or a vertex, and including the candidate groups of the multiple well positions, respectively as the first regions R₁ₐ, R_{1b}, R_{1c}, R_{1d}, and R₁ₑ for the respective wells, in determining the first regions R₁ₐ, R_{1b}, R_{1c}, R_{1d}, and R₁ₑ. As a result, as illustrated in FIG. 4, the first regions R₁ₐ, R_{1b}, R_{1c}, R_{1d}, and R₁ₑ for the respective well positions may have a clustered shape sharing the corner, and at this time, first regions for two or more well positions may be partially overlapped.

Subsequently, the processor repeats an operation of setting first combinations of representative positions in the multiple first regions R₁ₐ, R_{1b}, R_{1c}, R_{1d}, and R₁ₑ as the first search space, inputting the first search space into a pre-trained neural network model, and identifying a prediction value for each combination, and updating first combinations in which the prediction values are equal to or more than a reference value to the first search space, to gradually reduce the first search space (S30).

Here, the representative positions may be set to a central position of at least one first grid constituting the first regions R₁ₐ, R_{1b}, R_{1c}, R_{1d}, and R₁ₑ. For example, in the example illustrated in FIG. 4, when a size of the first region R₁ₐ for the first well is configured by eight grids of 5×5, the representative positions of the corresponding first region R₁ₐ may be set to a central position of eight grids, i.e., a position corresponding to three rows and three columns of each grid.

In the present disclosure, the neural network model may be a deep learning model pre-trained to receive grids combined with the number of target well positions to be determined by the grid model 1, and output a global solution which is proportion to the total oil or gas production amount or the net present value (NPV). In an example illustrated in the drawing of this specification, since five well positions are to be determined, in the corresponding example, the neural network model may be pre-trained to receive a grid combination constituted by five grids, and output a global solution which is in proportion to the total oil or gas production amount or the net present value (NPV).

Meanwhile, in this specification, for convenience of description, data input into the neural network model is described as ‘grid’, but this may not include single data, but a position of a grid, a distance (−4-way distance) up to an external, boundary of the grid model 1 from the corresponding position, a distance between different wells, physical property information of the oil or gas reservoirs set in the corresponding grid, etc.

The neural network repeat learning, and expected value output according to step S30, and the processor repeatedly updates the first search space according to the output of the neural network model.

Hereinafter, a process in which the processor trains the neural network model, and gradually reduces the first search space by using the neural network model will be described.

Referring to FIG. 5, the method for reducing the search space by using the neural network model according to an exemplary embodiment of the present disclosure may include step S110 of constructing, as training data, N training grid combinations selected in the search space, and a calculation value output by inputting the selected combinations into a computational model, step S120 of performing supervised learning of the neural network model by using the training data, step S130 of identifying a prediction value for each grid combination by inputting all available grid combinations in the search space into the neural network model, step S140 of updating multiple grid combinations corresponding to a prediction value in an upper rank to the search space, step S150 of identifying the number of T of non-training grid combinations not included in the training grid combination among grid combinations of the upper rank, and comparing the number of non-training grid combinations and the number of initial training grid combinations (N) (S160), and step S180 of adding, to the training data, N grid combinations selected among the non-training grid combinations, and a calculation value output by inputting N grid combinations into the computational model 1 model to the training data when the number of non-training grid combinations is larger than the number of initial training grid combinations.

However, the method for reducing the search space illustrated in FIG. 5 follows an exemplary embodiment, and respective steps constituting the present disclosure are not limited to the exemplary embodiment illustrated in FIG. 5 and if necessary, some steps may be added, modified, or deleted.

The method for training the neural network model illustrated in FIG. 5 may be performed in each of step S30, step S50, and step S70 illustrated in FIG. 2, and hereinafter, each of the steps illustrated in FIG. 5 will be described in detail for the first search space corresponding to the first region determined in step S20.

The processor may set the first combinations of the representative positions in the first region determined in step S20 as the first search space. In the present disclosure, the search space does not mean a physical space, but may mean the combinations of the representative positions, i.e., the number of cases generated by combining the representative positions.

For example, as illustrated in FIG. 4, when the first regions R₁ₐ, R_{1b}, R_{1c}, R_{1d}, and R₁ₑ are determined, the processor may set the combinations of the representative positions in the first region, specifically, set, as the first search space, a total of 30240 8×6×9×10×7 combinations of eight representative positions in the region R₁ₐ, six representative positions in the region R_{1b}, nine representative positions in the region R_{1c}, 10 representative positions in the region R_{1d}, and seven representative positions in the region R₁ₑ.

Subsequently, the processor may construct training data having N training grid combinations arbitrarily selected within the first search space as input data, and N calculation values output by inputting N training grid combinations into the computational model (S110).

Subsequently, the processor may perform supervised learning of the neural network model by setting N training grid combinations as the input data of the neural network model, and setting N calculation values as the output data of the neural network model (S120). According to the supervised learning, the neural network model may learn a correlation between the training grid combination, i.e., a combination of well candidate positions, and a calculation value of the computational model, for example, an oil or gas production amount.

Subsequently, the processor may identify the prediction value for each grid combination by inputting all available grid combinations within the search space, i.e., 30240 grid combinations into the neural network model in the example of FIG. 4 (S130).

Since the neural network model is in a state of learning a correlation between the grid combination, and the calculation value by the computational model according to step S120, a total of 30240 grid combinations are input to output 3024-prediction values (e.g., an oil or gas prediction production amount) corresponding to the corresponding combination regardless of whether a specific grid combination is used for learning.

Subsequently, the processor may update multiple grid combinations in which the prediction value is equal to or more than a reference value, specifically, the prediction value is within the upper rank as a whole to the first search space (S140).

Specifically, in the above example, the processor may identify 6048 prediction values, which are high at the top 20% among 30240 the prediction values, and update grid combinations corresponding to the corresponding prediction values to the first search space. As a result, the first search space may be reduced from the existing size to the size of 20%.

Subsequently, the processor may perform supervised learning of the neural network model by adding a grid combination except for the training grid combination among the grid combinations in which the prediction value is equal to or more than the reference value to the training data. As described above, the neural network model outputs the global solution which is in proportion to the total oil or gas production amount or the net present value (NPV), and the present disclosure attempts to determine a position of a well corresponding to an output value, so if there is a grid combination which is not used for pre-training among the grid combinations corresponding to the prediction value of the upper rank, the processor may additionally train the neural network model by using the corresponding grid combinations.

Subsequently, the processor may re-identify the prediction value for each combination by inputting the first search space updated in step S140 into the above re-trained neural network model, and re-update in which the re-identified prediction value is equal to or more than the reference value (e.g., top 20%) to the first search space. In the above example, whenever such a re-update operation is repeated, 30240 may be reduced to approximately 6048, and 6000 may be reduced to approximately 1210 by 80% in the first search space.

The re-training of the neural network model and the re-update operation of the first search space may be repeatedly performed until the number of non-training grid combinations is smaller than a reference number, and specifically, may be repeatedly performed according to the following order.

Referring back to FIG. 5, the processor may identify the number T of non-training grid combinations not included in the training data in step S110 among multiple grid combinations identified in step S140 (S150).

In the above example, the processor may identify 6048 grid combinations in which the prediction value is the top 20%, and identify the number T of non-training grid combinations not included in the training data among them.

Subsequently, the processor may compare the number T of non-training grid combinations and the reference number (may be set to the number N of initial training grid combinations, but is not limited thereto) (S160). According to a comparison result, when the number T of non-training grid combinations is equal to or more than the reference number N, N grid combinations may be arbitrarily selected among T non-training grid combinations, and N selected grid combinations, and N calculation values output by inputting N grid combinations into the computational model may be added to the training data. Specifically, N selected grid combinations is additional input data, and N calculation values as additional output data may be added to the training data.

Subsequently, the process below step S120 illustrated in step S120 may be repeatedly performed, and according to repeated training, in a comparison of step S160, when the number T of non-training grid combinations is smaller than the reference number N, training the neural network model and updating the first search space may be terminated.

Referring back to FIG. 2, the processor identifies a first fitness by inputting the reduced first search space into the computational model, and partitions the grid model into the second grid smaller than the first grid to determine each of multiple second regions including respective candidate groups of multiple well positions corresponding to the first combination in which the first fitness is equal to or more than a reference value. That is, the processor may significantly reduce computational resources by inputting only the first search space very reduced through the process illustrated in FIG. 5 into the computational model.

The computational model may be set in advance to receive grids combined with the number of target well positions, and output a fitness which is in proportion to the total oil or gas production amount or the natural present value (NPV). The processor may identify the first fitness for each first combination by inputting the first search space reduced as above into the computational model. Meanwhile, at this time, in FIG. 5, when training is terminated as the number T of non-training grid combinations is smaller than the reference number, the processor may also identify the first fitness by inputting the remaining non-training grid combinations into the computational model.

Subsequently, the processor partitions the grid model 1 into the second grid smaller than the first grid to determine multiple second regions including respective candidate groups of multiple well positions corresponding to the first combination in which the first fitness is equal to or more than the reference value.

The processor may first identify the candidate groups of multiple well positions corresponding to the first combination in which the first fitness is equal to or more than the reference value. Here, the reference value may also be set to a specific value, and also be set to an upper ratio or rank for the entirety.

Jointly referring to FIGS. 4 and 6, the processor may identify combinations determined based on the respective first regions R₁ₐR_{1b}, R_{1c}, R_{1d}, and R₁ₑ for the respective well positions, and having the fitness corresponding to the first search space reduced according to the process illustrated in FIG. 5 is equal to or more than the reference value, and determine a region corresponding combination as the candidate groups R_{1a_c}, R_{1b_c}, R_{1c_c}, R_{1d_c}, and R_{1e_c} of multiple well positions.

Subsequently, the processor partitions the grid model 1 into the second grid smaller than the first grid to determine each of multiple second regions including the respective candidate groups R_{1a_c}, R_{1b_c}, R_{1c_c}, R_{1d_c}, and R_{1e_c} of multiple well positions determined as above.

Jointly referring to FIGS. 4 and 7, when the first grid has the size of 5×5, the processor may partition the grid model 1 into a grid having a smaller size than the first grid, for example, the second grid of 3×3, and determine one or more second grids including the candidate groups R_{1a_c}, R_{1b_c}, R_{1c_c}, R_{1d_c}, and R_{1e_c} of multiple well positions determined as above as second regions R₂ₐ, R_{2b}, R_{2c}, R_{2d}, and R₂ₑ for the respective wells.

However, by considering that a maximum total oil or gas production amount or net pressure value (NPV) may be obtained in a region which partially deviates from the second grid due to uncertainty of the oil or gas reservoirs, the processor may identify second grids disposed to be adjacent to each other to share a corner or a vertex, and including the candidate groups R_{1a_c}, R_{1b_c}, R_{1c_c}, R_{1d_c}, and R_{1e_c} of multiple well positions, respectively, in determining the second regions R₂ₐ, R_{2b}, R_{2c}, R_{2d}, and R₂ₑ, and determine regions in which the second grids for the respective well positions are extended by a predetermined reference margin as the second regions R₂ₐ, R_{2b}, R_{2c}, R_{2d}, and R₂ₑ.

Subsequently, the processor repeats an operation of setting second combinations of the representative positions in the respective second regions R₂ₐ, R_{2b}, R_{2c}, R_{2d}, and R₂ₑ as the second search space, inputting the second search space into the neural network model, and identifying the prediction value for each combination, and updating the second combinations in which the prediction value is equal to or more than the reference value to the second search space to reduce the second search space (S50).

As described above, here, the representative positions may be set to a central position of at least one second grid constituting the second regions R₂ₐ, R_{2b}, R_{2c}, R_{2d}, and R₂ₑ. For example, in the example illustrated in FIG. 7, when a size of the second region R₂ₐ for the first well is configured by 26 grids of 3×3, the representative positions of the corresponding second region R₂ₐ may be set to a central position of 26 grids, i.e., a position corresponding to two rows and two columns of each grid.

Meanwhile, since each operation in step S50, and step S60 to be described below is similar to the operation in step S30 and step S40 described above, contents which are not described below should be appreciated as the same as the above-described contents. In particular, an operation of additional training of the neural network model and updating of the search space is the same as the operation of step S30, so here, additional description will be omitted.

Subsequently, the processor identifies a second fitness by inputting the reduced first search space into the computational model, and partitions the grid model into a third second grid smaller than the second grid to determine multiple third regions including respective candidates of multiple well positions corresponding to a second combination in which a second fitness is equal to or more than a second reference. Here, computational resources may be significantly reduced by inputting only the second search space very reduced through step S50.

The processor may first identify the candidate groups of multiple well positions corresponding to the second combination in which the second fitness is equal to or more than the reference value. Here, the reference value may also be set to a specific value, and also be set to an upper ratio or rank for the entirety.

Jointly referring to FIGS. 7 and 8, the processor may identify combinations determined based on the respective second regions R₂ₐ, R_{2b}, R_{2c}, R_{2d}, and R₂ₑ for the respective well positions, and having the fitness corresponding to the second search space reduced according to the process illustrated in FIG. 5 is equal to or more than the reference value, and determine a region corresponding combination as the candidate groups R_{2a_c}, R_{2b_c}, R_{2c_c}, R_{2d_c}, and R_{2e_c} of multiple well positions.

Subsequently, the processor partitions the grid model into the third grid smaller than the second grid to determine multiple third regions including the candidate groups R_{2a_c}, R_{2b_c}, R_{2c_c}, R_{2d_c}, and R_{2e_c}) of multiple well positions determined as above. At this time, a size of the third grid may be the same as the default grid, or may be large within a reference range. That is, in the present disclosure the sizes of the grids constituting the regions are gradually smaller, and may be the same as the default grid or may be reduced up to a degree slightly larger than the default grid.

Jointly referring to FIGS. 8 and 9, when the second grid has the size of 3×3, the processor may partition the grid model 1 into the third grid which is smaller than the second grid and has the same 1×1 as the default grid, and determine one or more third grids including the candidate groups R_{2a_c}, R_{2b_c}, R_{2c_c}, R_{2d_c}, and R_{2e_c} of multiple well positions determined as above as third regions R₃ₐ, R_{3b}, R_{3c}, R_{3d}, and R₃ₑ for the respective wells positions.

Here, by considering that the maximum total oil or gas production amount or the net present value (NPV) may be obtained in a region which partially deviates from the third grid due to the uncertainty of the oil or gas reservoirs, the processor may finally determine a region in which at least one third grid is extended by a predetermined reference margin as the third regions R₃ₐ, R_{3b}, R_{3c}, R_{3d}, and R₃ₑ in determining the third regions.

Subsequently, the processor repeats an operation of setting all default grids within any one target third region among multiple third regions, and third combinations within representative positions within the remaining third regions as a third search space, inputting the third search space into the neural network model, and identifying a prediction value for each combination, and updating third combinations in which the prediction value is equal to or more than a reference value to the third search space to reduce the third search space (S70).

As described above, here, the representative positions may be set to a central position of at least one third grid constituting the third regions R₃ₐ, R_{3b}, R_{3c}, R_{3d}, and R₃ₑ. However, in this step, in searching the third search space, the representative positions of all of the third regions R₃ₐ, R_{3b}, R_{3c}, R_{3d}, and R₃ₑ are not used, and for any one third region, all default grids in the corresponding region may be used, and for other third regions, the representative position may be used. That is, since the third regions R₃ₐ, R_{3b}, R_{3c}, R_{3d}, and R₃ₑ have a sufficient small range through the above-described process, the processor may set combinations of all internal default grids as the search space for any one region of the multiple third regions. R₃ₐ, R_{3b}, R_{3c}, R_{3d}, and R₃ₑ

When FIG. 9 is described as an example, when the third region R_{3b} for the second well is set as a target third region, the processor may set, as the third search space, a total of 18900 (25×6×6×7×3) combinations which are combinations of 25 default grids within the corresponding region R_{3b}, Six representative positions in the region R₃ₐ, six representative positions in the region R_{3c}, seven representative positions in the region R_{3d}, and three representative positions in the region R₃ₑ.

When the third search space is set, the processor repeats the update operation of the third search space to gradually reduce the third search space, and such an operation is the same as the operation described in steps S30 and S50, so here, any longer description will be omitted.

Subsequently, the processor inputs the reduced third search space into the computational model to determine a well position having a maximum fitness for any one target third region (S80).

In the example described above with reference to FIG. 9, since all default grids are utilized for setting the third search space with respect to the target third region R_{3b} for the second well, the default grids in the target third region R_{3b} may also be included in the reduced third search space. The processor may identify any one combination having a maximum fitness output from the computational model among the third combinations constituting the reduced third search space, and determine, as a position of the second well, a single default grid position of the target third region R_{3b} included in the corresponding combination.

At this time, in order to reduce the computational resources of the computational model, specifically, the number of cases of the combinations input into the computational model, any one target third with to the default grid is to be combined among multiple third regions R₃ₐ, R_{3b}, R_{3c}, R_{3d}, and R₃ₑ may be sequentially selected in order of a smaller width.

Referring back to the example illustrated in FIG. 9, the processor sets a region R_{3b} for the second well, which has a largest width among the multiple third regions R₃ₐ, R_{3b}, R_{3c}, R_{3d}, and R₃ₑ as the target third region to determine the position of the second well, and then, sets a region R₃ₑ for the fifth well, which has a second largest width as a subsequent target third region to determine a position of the fifth well. In the same scheme, the processor may sequentially set the remaining regions as the target third region in order of smaller width to thereby sequentially determine a position of the third well, a position of the first well, and a position of the fourth well.

Specifically, the processor may set, as a fourth search space, the well position of any one region described above, fourth combinations of all default grids in another region among the multiple third regions, and representative positions in the remaining third regions, and gradually reduce the fourth search space according to the above-described method. Subsequently, the processor reduces the fourth search space according to the method described above and inputs the reduced fourth search space into the computational model to determine the well position having the maximum fitness with respect another third region.

In the example illustrated in FIG. 9, the processor may set, as the fourth search space, a total of 13860 (1×55×6×6×7) combinations which are combinations of the single position of the second well determined as above, 55 default grids in the third region R₃ₑ for the fifth well, six representative positions in the region R₃ₐ, six representative positions in the region R_{3c}, and seven representative positions in the region R_{3d}.

Subsequently, the processor reduces the fourth search space according to the method described above and inputs the reduced fourth search space into the computational model to determine the position of the fifth well having the maximum fitness.

In the same method, the processor may reset, as the fourth search space, a total of 3696 (1×1×88×6×7) combinations which are combinations of the position of each of the second and fifth wells described above, 88 default grids for the third well, six representative positions in the region R₃ₐ, and seven representative positions in the region R_{3d}.

Subsequently, the processor reduces the fourth search space according to the method described above and inputs the reduced fourth search space into the computational model to determine the position of the third well having the maximum fitness.

The processor may repeatedly perform such an operation until the positions of all wells are determined, and as a result, the positions of five wells may be specified as the single default grid as illustrated in FIG. 10.

Hereinafter, the operation of the present disclosure for the grid model 1 illustrated in FIG. 1 will be summarized with reference to FIGS. 11 to 15.

Referring to FIG. 11, the processor may derive combinations of positions of five wells which maximize the objective function which is in proportion to a total oil or gas production amount or a net present value (NPV) by repeatedly applying the POA to the grid model 1 nine times.

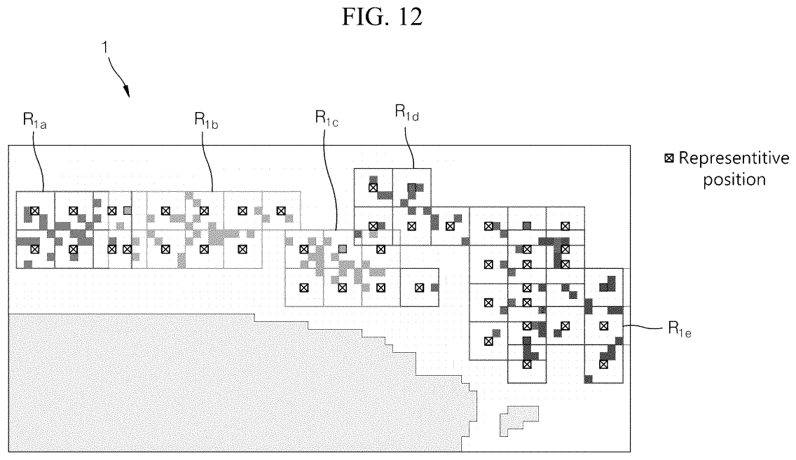

Subsequently, referring to FIG. 12, the processor may partition the grid model 1 into 5×5 grids, and may determine the first grids including all candidate groups of the respective wells identified above as first regions R₁ₐ, R_{1b}, R_{1c}, R_{1d}, and R₁ₑ for the respective wells. At this time, some of the first regions for the respective wells may be overlapped.

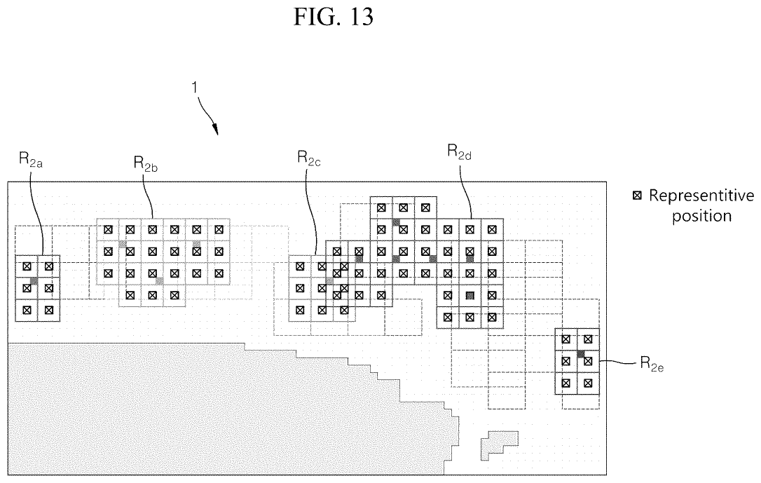

Subsequently, referring to FIG. 13, the processor may set, as the first search space, combinations of representative positions in the first regions R₁ₐ, R_{1b}, R_{1c}, R_{1d}, and R₁ₑ, and gradually reduce the first search space according to the method described with reference to FIG. 5. The processor may identify a fitness for each combination by inputting the reduced first search space into the computational model, and partition the gird model into 3×3 grids, and determine second regions R₂ₐ, R_{2b}, R_{2c}, R_{2d}, and R₂ₑ including candidate groups of five well positions in which the fitness is equal to or more than a reference value, respectively. At this time, it is described above that the second regions R₂ₐ, R_{2b}, R_{2c}, R_{2d}, and R₂ₑ for the respective wells may be defined as regions in which regions formed by 3×3 grids including the candidate groups of the respective well positions are expanded by a reference margin.

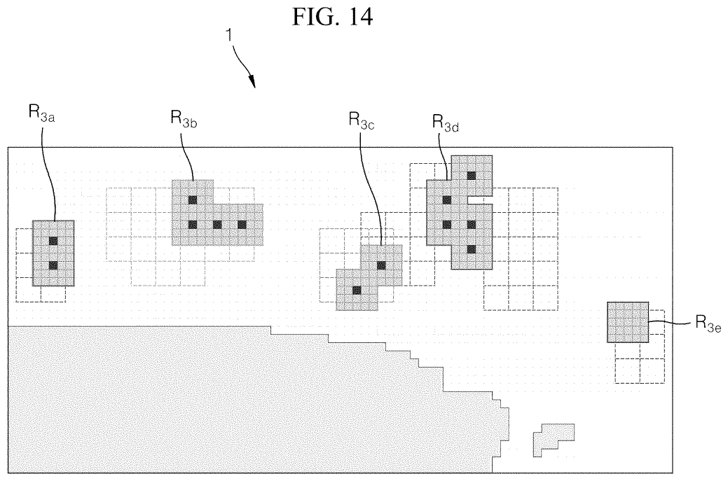

Subsequently, referring to FIG. 14, the processor may set, as the second search space, combinations of representative positions in the second regions R₂ₐ, R_{2b}, R_{2c}, R_{2d}, and R₂ₑ, and gradually reduce the second search space according to the method described with reference to FIG. 5. The processor may identify a fitness for each combination by inputting the reduced second search space into the computational model, and partition the gird model into 1×1 grids, and determine third regions R₃ₐ, R_{3b}, R_{3c}, R_{3d}, and R₃ₑ including candidate groups of five well positions in which the fitness is equal to or more than a reference value, respectively. Similarly, it is described above that the third regions R₃ₐ, R_{3b}, R_{3c}, R_{3d}, and R₃ₑ for the respective wells may be defined as regions in which regions formed by 1×1 grids including the candidate groups of the respective well positions are expanded by a reference margin.

Subsequently, referring to FIG. 14, the processor may set, as the third search space, third combinations of default grids in any one region sequentially selected in order of smaller width among multiple third regions R₃ₐ, R_{3b}, R_{3c}, R_{3d}, and R₃ₑ, and representative positions in the remaining third regions, and reduce the third search space according to the method described with reference to FIG. 5. The processor inputs the reduced third search space to determine the well position having the maximum fitness for each of the sequentially selected third regions R₃ₐ, R_{3b}, R_{3c}, R_{3d}, and R₃ₑ.

Specifically, in the example illustrated in FIG. 14, the processor may first set, as the third search space, combinations of all default grids in the third region R₃ₑ for the fifth well having a smallest width, and representative positions in other third regions R₃ₐ, R_{3b}, R_{3c}, and R_{3d}, and gradually reduce the third search space according to the method illustrated in FIG. 5. Subsequently, the processor inputs the reduced third search space into the computational model to determine the position of the fifth well having the maximum fitness.

Next, the processor may set, as the fourth search space, combinations of all default grids in the third region R₃ₑ for the fifth well having a second smallest width, and representative positions in the remaining third regions R_{3b}, R_{3c}, and R_{3d}, and gradually reduce the fourth search space according to the method illustrated in FIG. 1. Subsequently, the processor inputs the reduced fourth search space into the computational model to determine the position of the first well having the maximum fitness.

Next, the processor may set, as the fifth search space, combinations of the positions of the first and fifth wells determined as above, and all default grids in the third region R_{3c} for the third well having a third smallest width, and representative positions in the remaining third regions R_{3b} and R_{3d}, and gradually reduce the fifth search space according to the method illustrated in FIG. 5. Subsequently, the processor inputs the reduced fifth search space into the computational model to determine the position of the third well having the maximum fitness.

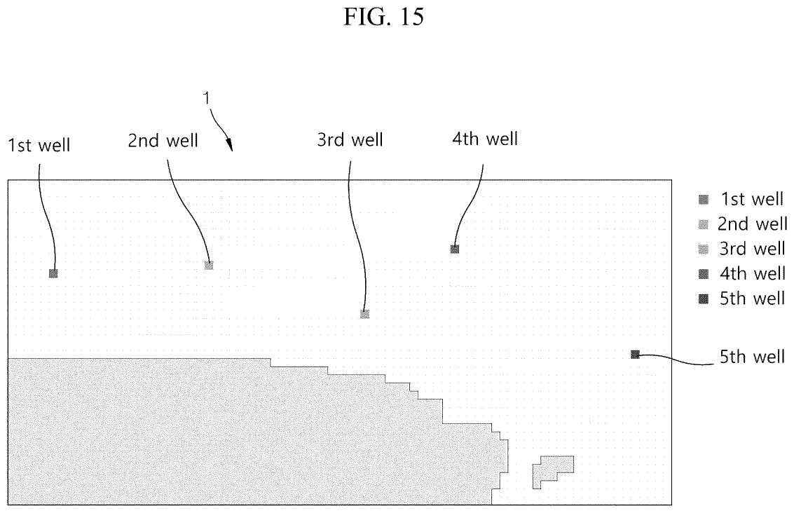

The processor repeatedly performs such a scheme to determine all of the positions of the first to fifth wells, and as a result, the positions of five wells may be specified as the single default grid as illustrated in FIG. 15.

As described above, according to the present disclosure, there is an advantage in that it is possible to specify a well position with a small time and resources, and high accuracy even in oil or gas reservoirs in which a size of a search space is very large by appropriately combining a population-based optimization algorithm (POA) and an inference operation of a neural network model.

Referring to FIG. 16, it can be seen that in the operation of determining five well positions for the oil or gas reservoirs illustrated in FIG. 1, when only the DECE algorithm provided by the CMG is utilized as the population-based optimization algorithm (POA), an accumulated oil or gas production amount of U.S. Pat. No. 3,172,245 (stb) may be achieved through a simulation for 2923 cases, while when the present disclosure is applied, an accumulated oil or gas production amount of U.S. Pat. No. 3,233,490 (stb) may be achieved only through a simulation for 1372 cases.

Although the present disclosure has been described above by the drawings, but the present disclosure is not limited by the exemplary embodiments and drawings disclosed in the present disclosure, and various modifications can be made from the above description by those skilled in the art within the technical ideas of the present disclosure. Moreover, even though an action effect according to a configuration of the present disclosure is explicitly disclosed and described while describing the exemplary embodiments of the present disclosure described above, it is natural that an effect predictable by the corresponding configuration should also be conceded.

What is claimed is:

1. A method for determining multiple well positions in a 3D grid model for oil or gas reservoir partitioned into multiple default grids, the method comprising:
identifying, by a processor, each of candidate groups of multiple well positions in the grid model through a population-based optimization algorithm (hereinafter, referred to as POA);
partitioning, by the processor, the grid model into first grids larger than a default grid, and determining each of multiple first regions including each candidate group;
repeating, by the processor, an operation of setting first combinations of representative positions in each first region as a first search space, inputting the first search space into a pre-trained neural network model, and identifying a prediction value for each combination, and reducing the first search space;
identifying, by the processor, a first fitness by inputting the reduced first search space into the computational model, and partitioning the grid model into second grids smaller than the first grids to determine multiple second regions including respective candidate groups of multiple well positions corresponding to the first combination in which the first fitness is equal to or more than a reference value;
repeating, by the processor, an operation of setting second combinations of representative positions in each second region as a second search space, inputting the second search space into the neural network model, and identifying a prediction value for each combination, and reducing the second search space;
identifying, by the processor, a second fitness by inputting the reduced second search space into the computational model, and partitioning the grid model into third grids smaller than the second grids to determine multiple third regions including respective candidate groups multiple well positions corresponding to the second of combination in which the second fitness is equal to or more than a reference value;
repeating, by the processor, an operation of setting third combinations of all default grids within any one third region among the multiple third regions, and representative positions within the remaining third regions as a third search space, inputting the third search space into the neural network model, and identifying a prediction value for each combination, and updating third combinations in which the prediction value is equal to or more than a reference value to the third search space to reduce the third search space; and
inputting, by the processor, the reduced third search space into the computational model, and determining a well position having a maximum fitness with respect the any one third region.

2. The method for determining multiple well positions of claim 1, wherein the POA is any one of a genetic algorithm (GA), a particle swarm optimization (PSO) algorithm, and a designed exploration and controlled evolution (DECE) algorithm.

3. The method for determining multiple well positions of claim 1, wherein the identifying of the candidate groups of the multiple well positions includes
identifying, as the candidate groups of the multiple well positions, combinations of multiple well positions having a solution having a predetermined upper rank by repeatedly applying the POA to the grid model a reference number of times.

4. The method for determining multiple well positions of claim 1, wherein an objective function of the POA is set to be in proportion to a total oil or gas production amount or a net present value (NPV).

5. The method for determining multiple well positions of claim 1, wherein the determining of the first region includes
determining each of the first grids disposed to be adjacent to each other, and including the candidate groups of the multiple well positions, respectively as the first region.

6. The method for determining multiple well positions of claim 1, wherein the neural network model is pre-trained to receive grids combined with the number of target well positions in the grid model, and output a global solution which is in proportion to the total oil or gas production amount or the net present value (NPV).

7. The method for determining multiple well positions of claim 1, wherein the neural network model is subjected to supervised learning based on training data having multiple training grid combinations selected in the first search space as input data, and a calculation value output by inputting the training grid combinations into the computational model as output data.

8. The method for determining multiple well positions of claim 7, wherein the reducing of the first search space includes
supervised learning the neural network model again by adding a first combination except for the training grid combination among the first combinations in which the prediction value is equal to or more than the reference value to the training data, and
re-identifying the updated first search space into the re-trained neural network model, and re-updating the first combinations in which the re-identified prediction value is equal to or more than the reference value to the first search space.

9. The method for determining multiple well positions of claim 8, wherein the re-updating of the first search space is repeated until the number of first combinations except for the training grid combination becomes smaller than a reference number.

10. The method for determining multiple well positions of claim 1, wherein the identifying of the first and second fitnesses includes
inputting the first and second search spaces into the computational model preset to output a fitness which is in proportion to the total oil or gas production amount or the net present value (NPV).

11. The method for determining multiple well positions of claim 1, wherein the third grid is the same as the default grid, or is large within a reference range.

12. The method for determining multiple well positions of claim 1, wherein the determining of the second and third regions includes
identifying second and third grids disposed to be adjacent to each other, and including respective candidates of multiple well positions corresponding to the first and second combinations, and
determining regions in which the second and third grids are expanded by a reference margin as the second and third regions, respectively.

13. The method for determining multiple well positions of claim 1, wherein the any one third region is selected in order of smaller width among the multiple third regions.

14. The method for determining multiple well positions of claim 1, further comprising:
repeating, by the processor, an operation of setting fourth combinations of the determined well position of any one third region, all default grids within another third region among the multiple third regions, and representative positions within the remaining third regions as a fourth search space, inputting the fourth search space into the neural network model, and identifying a prediction value for each combination, and updating fourth combinations in which the prediction value is equal to or more than a reference value to the fourth search space to reduce the third search space; and
inputting, by the processor, the reduced fourth search space into the computational model, and determining a well position having a maximum fitness with respect another third region.
